(19) United States
(12) Patent Application Publication
(10) Pub. No.: US 2013/0246832 A1
(43) Pub. Date: Sep. 19, 2013

(54) INFORMATION PROCESSING DEVICE, COMPUTER-READABLE RECORDING MEDIUM HAVING STORED THEREIN PROGRAM FOR SETTING TIME OF INFORMATION PROCESSING DEVICE, MONITOR, AND METHOD FOR SETTING TIME OF INFORMATION PROCESSING DEVICE

(71) Applicant: FUJITSU LIMITED, Kawasaki-shi (JP)

(72) Inventor: KATSUHIKO FUNAKI, Yokohama (JP)

(73) Assignee: FUJITSU LIMITED, Kawasaki-shi (JP)

(21) Appl. No.: 13/870,020

(22) Filed: Apr. 25, 2013

Related U.S. Application Data
(63) Continuation of application No. PCT/JP2010/069698, filed on Nov. 5, 2010.

(51) Int. Cl. G06F 1/12

(52) U.S. Cl. CPC G06F 1/12
USPC 713/400

(57) ABSTRACT

An information processing device includes a monitoring object device, a monitor that monitors the monitoring object device, a controller including a first time source, a base monitor including a second time source, and a console. The controller sets times of the first time source and the monitoring object device on the basis of an instruction of time setting from the console and then transmits notification of time setting completion to the console. When an exclusive relationship that the base monitor is not allowed to set a time in the second time source under a state where the controller is running is established, the console stops the controller, causes the base monitor to set a time in the second time source after the reception of the notification of time setting completion. After time setting in the second time source is completed, the console restarts the controller and the base monitor.

### CROSS REFERENCE OF RELATED APPLICATION

This application is a continuation application of International Application PCT/JP2010/069698 filed on Nov. 5, 2010 and designated the U.S., the entire contents of which are incorporated herein by reference.

### FIELD

The embodiments discussed herein are an information processing device including a monitoring object device and a monitor that monitors the monitoring object device, a computer-readable recording medium having stored therein a program for setting a time of the information processing device, the monitor, and a method for setting time of the information processing device.

### BACKGROUND

FIG. 9 is a diagram illustrating an example of the configuration of an information processing device 100 including a monitor (integrated monitor) 110 and a monitoring object device 150.

As illustrated in FIG. 9, the monitor 110 regards at least one server 160, a memory 170, and at least one Input Output (I/O) unit 180 as an integrated monitoring object device 150, and monitors the integrated monitoring object device 150. The monitor 110 includes a base 120, a console 130, and a clock device 140.

The base 120 monitors the monitoring object device 150 and the console 130, and includes a controller 121, a first time source 122, a base monitor 123, and a second time source 124.

The controller 121 controls the monitoring object device 150, and also controls reception of a time from the clock device 140. An example of the controller 121 is a hypervisor that manages Operating System (OS).

The base monitor 123 monitors the base 120 itself and is exemplified by a service processor.

The first time source 122 provides a time to be used in an OS managed by the controller 121, and the second time source 124 provides a time to be used by the base monitor 123. This means that the controller 121 and the base monitor 123 have respective time sources.

The first time source 122 synchronizes the time of the first time source 122 itself with the time of the second time source 124 when the monitor 110 is started.

An example of the second time source 24 is a Time Of Day (TOD) clock.

Meanwhile, an example of the first time source 122 is a logical TOD clock.

The first time source 122 retains a time difference value between the time of the second time source 124 and the time used by the OS. The first time source 122 calculates the time of the OS managed by the controller 121 by adding the time of the second time source 124 and the time difference value and provides the calculated time to the OS managed by the controller 121. This means that the time of the first time source 122 is calculated using the time difference value depending on the time of the second time source 124 and the time of the second time source 124.

The console 130 controls the information processing device 100 via the user interface (not illustrated) such as a display, a keyboard, and/or a mouse.

The user can obtain monitoring information such as a system status and log data of the monitoring object device 150 via the console 130.

The user can set the time of the first time source 122 to desired time from the console 130. This means that the console 130 can set a time differential value that the first time source 122 retains to a time differential value between the desired time input by the user and the time of the second time source 124.

The clock device 140 provides the information processing device 100 with a time. An example of the clock device 140 is a Network Time Protocol (NTP) server, which may be installed outside the information processing device 100 and which may be accessible through a communication network.

The monitoring object device 150 includes at least one server 160, a memory 170, and at least one I/O unit 180, and is an object to be monitored by the monitor 110.

The server 160 is at least one large-scale server that shares the memory 170, which is a common memory device, and at least one I/O unit 180 is a device connected to an I/O interface of the server 160.

The monitor 110 has a time synchronizing function to distribute a time to the entire system from the controller 121.

The time synchronizing function has two functions of: a first function that causes the controller 121 serving as an NTP client to receive a time from the clock device 140 and distribute the received time to the entire system; and a second function that the controller 121 causes the first time source 122 to distribute a time to the monitoring object device 150 and the console 130.

The first function causes the clock device 140 serving as an NTP server to synchronize the times of the first time source 122, the second time source 124, the console 130, and the monitoring object device 150 with the time of the clock device 140.

The second function disables the time synchronization by the clock device 140 serving as an NTP server and instead synchronizes the times of the monitoring object device 150 and the console 130 with the time of the first time source 122.

Hereinafter, the second function is also referred to as a manual time synchronizing function.

The manual time synchronizing function makes the monitor 110 to set an arbitrary time input by the user from the console 130 to a time of the first time source 122 under the control of the controller 121.

Distributing the time of the first time source 122 which time is changed by the controller 121 to the monitoring object device 150 and the console 130, the manual time synchronizing function allows the user to verify the operation of the monitoring object device 150 at a desired time of testing.

One known technique is that the hypervisor can change a time and a clock speed of a logical time measuring mechanism of a logical central processing device when a virtual information processing device is both being activated and operating in the following procedure. Specifically, the hypervisor obtains time setting, a setting format, and parameter to change a clock speed that the console provides by activating a hypervisor assisting mechanism, and then stores the obtained time setting, setting format, and parameter to change a clock speed into an external storing device of the service processor and a time storing region of the hypervisor for each virtual information processing device.

Furthermore, another known technique is that the set time and the assigning format of a logical time that are once set to the logical time measuring mechanism are stored in an external storing device of the service processor, and a time is automatically set in the logical time measuring mechanism in obedience to the stored information, so that the times of inputs from the operator to set a time can be reduced.

### PRIOR ART REFERENCE

### Patent Literature

[Patent Literature 1] Japanese Laid-open Patent Publication No. 11-15558
[Patent Literature 2] Japanese Laid-open Patent Publication No. 2005-258501

In the above information processing device 100, the base monitor 123 that monitors the base 120 may refer to information of the OS managed by the controller 121. For example, in order to check the state of the OS managed by the controller 121, the user checks the log data of the OS managed by the controller 121 using the base monitor 123. In this case, the time, such as a time stamp, that is to be set in the information of the OS managed by the controller 121 is set by the controller 121 on the basis of the time of the first time source 122 of the controller 121.

As described above, after the console 130 changes the time of the first time source 122 of the controller 121 while the manual time synchronizing function is being executed in the monitor 110, the time used in the OS managed by the controller 121 has a difference of a time differential value from the time of the second time source 124.

For the above, the user obtains the time differential value from the controller 121 and then refers to the information of the OS managed by the controller 121 on the basis of the time obtained by adding the time differential value to the time of the second time source 124. Thereby, the user can synchronize the time of the base monitor 123, when the information of the OS managed by the controller 121 is to be referred, with the time of the OS managed by the controller 121, so that the user can refer to the information of the OS managed by the controller 121 without being affected by a time gap caused by the time differential value.

However, the above procedure needs to obtain the time differential value and adds the obtained time differential value to the time of the second time source 124 each time the user is to refer to the information of the OS managed by the controller 121, so that the procedures increase the load.

One solution to the above is that while the monitor 110 is executing the manual time synchronizing function, the user causes the console 130 to seta time in the second time source 124 of the base monitor 123 as well as the time of the first time source 122 of the controller 121.

Specifically, the time of the first time source 122 of the controller 121 is calculated on the basis of a time differential value depending on the time of the second time source 124 of the base monitor 123 and the time of the second time source 124. This means that the time of the second time source 124 is a reference to calculate the time of the first time source 122.

Some specifications of the base 120 may restrict time setting in the second time source 124 while the controller 121 is being activated not to affect the time of the first time source 122.

This means that some specifications of the base 120 may establish an exclusive relationship between time setting in the second time source 124 of the base monitor 123 and the state of the controller 121. In other words, while the controller 121 is running, time setting into the second time source 124 may sometimes be prohibited.

FIG. 10 illustrates the controller 121 setting a time in the second time source 124 of the base monitor 123 in the monitor 110 of FIG. 9 when an exclusive relationship is established between time setting into the second time source 124 and the state of the controller 121.

As illustrated in FIG. 10, when an exclusive relationship is established between time setting into the second time source 124 and the state of the controller 121, the controller 121 being running is prevented from a setting a time in the second time source 124 of the base monitor 123.

FIG. 11 illustrates a case where the console 130 is to set a time in the first and the second time sources 122 and 124 in the monitor 110 when an exclusive relationship is established between time setting into the second time source 124 and the state of the controller 121.

As illustrated in FIG. 11, when an exclusive relationship is established between time setting into the second time source 124 and the state of the controller 121, the console 130 allows the controller 121 being running to set a time in the first time source 122, but prevents the base monitor 123 from setting a time in the second time source 124.

FIG. 12 is a sequence diagram denoting procedural steps of the manual time synchronizing function performed in the monitor 110 of FIG. 9 when an exclusive relationship is established between time setting into the second time source 124 and the state of the controller 121.

As denoted in FIG. 12, the console 130 carries out the following procedural steps S101 to S112 if aiming at setting a time both in the first time source 122 of the controller 121 and the second time source 124 of the base monitor 123.

To begin with, the console 130 transmits, to the controller 121, an instruction to set the time in the first time source 122 (step S101). The instruction to set the time includes the arbitrary time input by the user.

Upon receipt of the instruction to set a time from the console 130, the controller 121 sets a time designated by the instruction to set a time in the first time source 122 (step S102).

Upon completion of time setting into the first time source 122, the controller 121 transmits time setting completion notification to the console 130 (step S103).

Upon receipt of the time setting completion notification from the controller 121 (step S104), the console 130 transmits an instruction to restart to the controller 121 (step S105) so that the time set in the first time source 122 is reflected in the controller 121.

Upon receipt of the instruction to restart from the console 130, the controller 121 restarts the 121 itself (step S106).

Along the above steps S101-S106, the console 130 causes the controller 121 to set a time in the first time source 122.

Next, the console 130 is to carry out following steps S107-S112 corresponding to the above steps S101-S106 in order to cause the base monitor 123 to set a time in the second time source 124.

The console 130 transmits an instruction to set a time in the second time source 124 to the base monitor 123 (step S107).

However, when an exclusive relationship is established between time setting in the second time source 124 and the state of the controller 121, the console 130 fails in causing the base monitor 123 to set a time in the second time source 124 as described above.

As illustrated in FIG. 12, when the base monitor 123 is executing step S108, the controller 121 finishes the restarting the controller 121 itself in step S106 and is in the running state. Accordingly, console 130 does not cause the base monitor 123 to set a time in the second time source 124.

Consequently, steps S108-S112 of FIG. 12 are not carried out by the monitor 110 of FIG. 9.

As described above, the manual time synchronizing function of the conventional monitor 110 causes the console 130 to instruct the controller 121 to set a time in the first time source 122.

However, when an above exclusive relationship is established due to the specification of the base 120, the console 130 does not allow the base monitor 123 to change the time of the second time source 124.

The above technique that the hypervisor can change a time and a clock speed of a logical time measuring mechanism of a logical central processing device when a virtual information processing device is both being activated and operating aims at setting a time of a logical TOD clock. Accordingly, this technique does not assume setting a time of a TOD clock or a case where a time setting in the TOD clock establishes an exclusive relationship with the state of the hypervisor.

### SUMMARY

According to an aspect of the embodiments, an information processing device including a monitoring object device and a monitor that monitors the monitoring object device, the monitor includes: a console that controls the information processing device in accordance with instruction information input through a user interface; and a base that monitors the monitoring object device, the base including a first time source that supplies a first time of the entire part of the information processing device based on time information from an external entity of the information processing device, a second time source that has a second time different from the first time of the first time source, a controller that controls the first time source and the monitoring object device, and a base monitor that controls the second time source and monitors the base, the controller including a first time setter that sets the first time in the first time source in accordance with an instruction to set a time from the console, that sets the first time, which is set in the first time source, in the monitoring object device, and that, upon completion of the setting of the first time in the monitoring object device, transmits a notification of time setting completion to the console, and the console including a stopper that stops, when an exclusive relationship that the base monitor is prohibited from setting the second time in the second time source under a state where a controller is running is established, the controller after the console receives the notification of time setting completion from the controller, a second time setter that causes, after the controller is stopped, the base monitor to set the second time in the second time source, and a restarter that restarts, upon receipt of a notification of time setting completion from the base monitor, the controller and the base monitor.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram schematically illustrating an example of the configuration of an information processing device according to a first embodiment;

FIG. 2 is a block diagram schematically illustrating an example of the hardware configuration of a base and a console of the first embodiment;

FIG. 3 is a diagram depicting an example of exclusion information retained by a controller of the first embodiment;

FIG. 4 is a sequential diagram denoting an example of a succession of procedural steps of a manual time synchronous function of an information processing device of the first embodiment;

FIG. 5 is a block diagram schematically illustrating an example of the configuration of an information processing device according to a second embodiment;

FIG. 6 is a block diagram schematically illustrating an example of the hardware configuration of a base and a console of the second embodiment;

FIG. 7 is a diagram depicting an example of exclusion information retained by a controller of the second embodiment;

FIG. 8 is a sequential diagram denoting an example of a succession of procedural steps of a manual time synchronous function of an information processing device of the second embodiment;

FIG. 9 is a block diagram schematically illustrating an example of the configuration of an information processing device including a monitor and a monitoring object device;

FIG. 10 is a diagram illustrating a relationship of a controller of FIG. 9 with a second time source;

FIG. 11 is a diagram illustrating a relationship of a console of FIG. 9 with a first time source and a second time source; and

FIG. 12 is a sequential diagram denoting an example of a succession of procedural steps of a manual time synchronous function of a monitor of FIG. 9.

### DESCRIPTION OF EMBODIMENTS

Hereinafter, embodiments of the present invention will now be described with reference to the accompanying drawings.

### (A) First Embodiment

(A-1) Configuration of First Embodiment

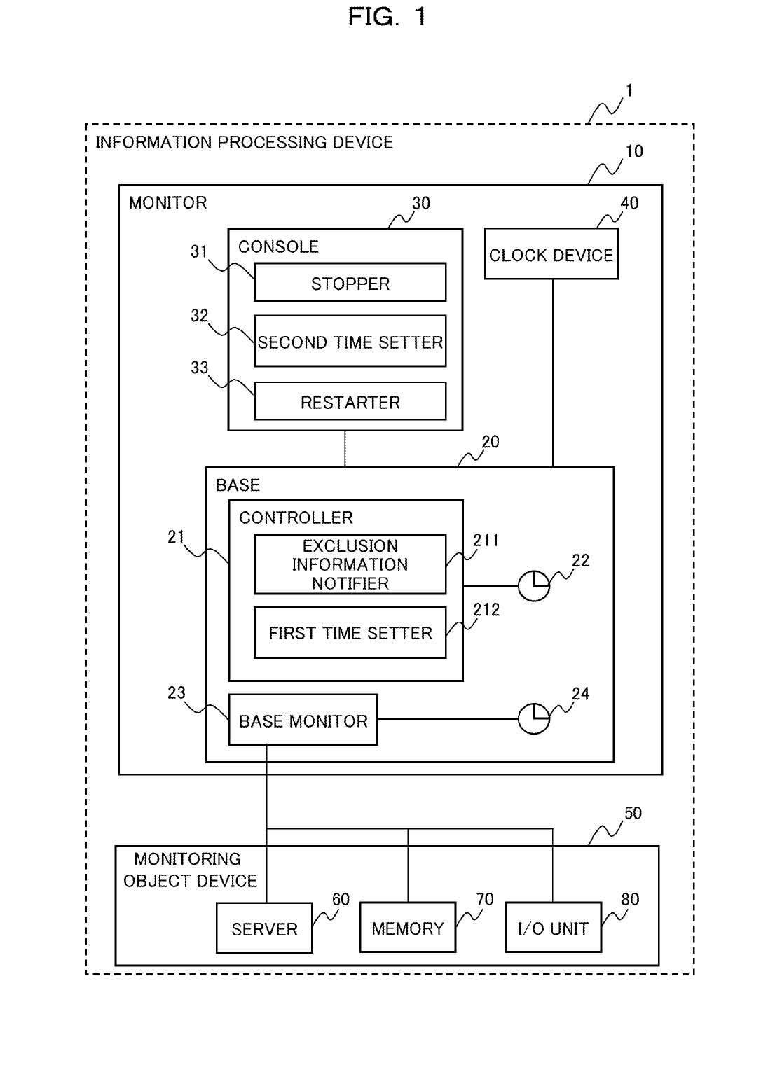

FIG. 1 is a block diagram schematically illustrating an example of the configuration of an information processing device 1 according to the first embodiment.

As illustrated in FIG. 1, the information processing device 1 includes a monitor 10 and a monitoring object device 50.

The monitor 10 regards at least one server 60, a memory 70, and at least one I/O unit 80 as an integrated monitoring object device 50, and monitors the integrated monitoring object device 50. The monitor 10 includes a base 20, a console 30, and a clock device 40.

The base 20 monitors the monitoring object device 50 and the console 30, and includes a controller 21, a first time source 22, a base monitor 23, and a second time source 24.

The controller 21 controls the monitoring object device 50, and also controls reception of a time from the clock device 40.

The controller 21 includes an exclusion information notifier 211 and a first time setter 212, and is exemplified by a hypervisor that manages the OS.

The exclusion information notifier 211 and the first time setter 212 will be detailed below.

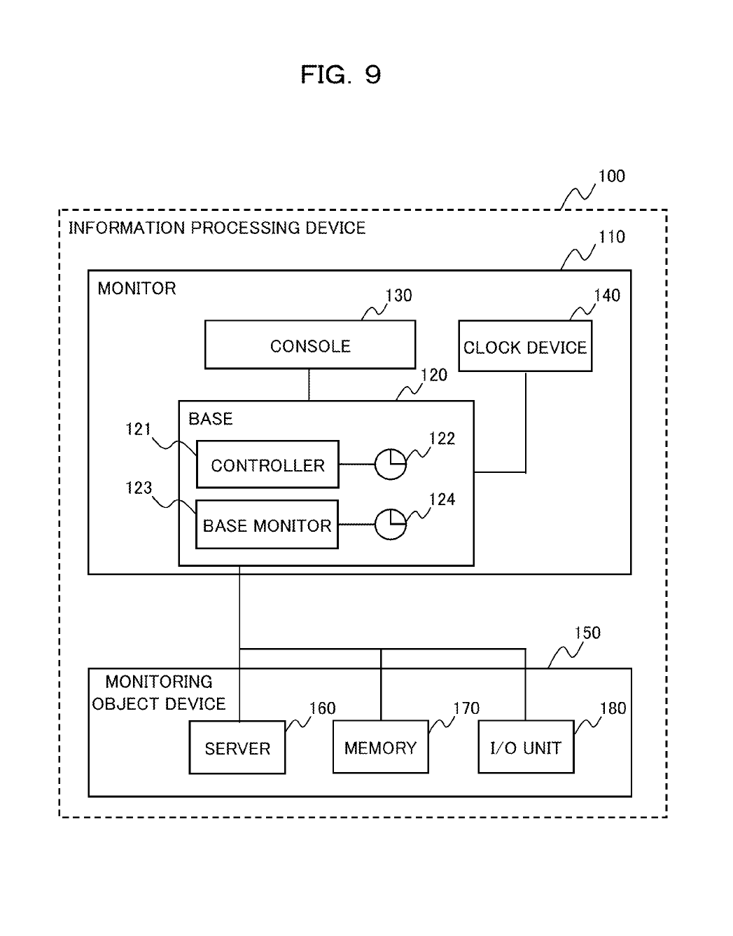

The base monitor 23 monitors the base 20 itself likewise the base monitor 123 described above with reference to FIG. 9. The base monitor 23 is exemplified by a service processor.

The first time source 22 provides a time to be used in an OS managed by the controller 21, and the second time source 24 provides a time to be used by the base monitor 23. This means that the controller 21 and the base monitor 23 have respective time sources.

The first time source 22 synchronizes the time of the first time source 22 itself with the time of the second time source 24 when the monitor 10 is started likewise the first time source 122 described as the above with reference to FIG. 9.

An example of the second time source 24 is a TOD clock and an example of the first time source 22 is a logical TOD clock.

The first time source 22 retains a time difference value between the time of the second time source 24 and the time used by the OS. The first time source 22 calculates the time of the OS managed by the controller 21 by adding the time of the second time source 24 and the time difference value. This means that the time of the first time source 22 is calculated using the time difference value depending on the time of the second time source 24 and the time of the second time source 24.

The console 30 controls the information processing device 1 via the user interface (not illustrated) such as a display, a keyboard, and/or a mouse.

The user can obtain monitoring information such as a system status and log data of the monitoring object device 50 via the console 30.

The user can set the times of the first time source 22 and the second time source 24 to desired time from the console 30. This means that the console 30 can set desired time input by the user in both the first time source 22 and the second time source 24. In other words, the console 30 can set the time of the second time source 24 such that the time difference value between the desired time input by the user and the time of the second time source 24 comes to be “0”.

The console 30 includes a stopper 31, a second time setter 32, and a restarter 33, which will be detailed below.

Likewise the clock device 140 described above with reference to FIG. 9, the clock device 40 provides the information processing device 1 with a time. An example of the clock device 40 is an NTP server, which may be outside the information processing device 1.

Likewise the monitoring object device 150 described above with reference to FIG. 9, the monitoring object device 50 includes at least one server 60, a memory 70, and at least one I/O unit 80, and is an object to be monitored by the monitor 10.

The server 60 is at least one large-scale server that shares the memory 70, which is a common memory device, and at least one I/O unit 80 is a device connected to an I/O interface of the server 60.

The monitor 10 has a time synchronizing function to distribute a time to the entire system from the controller 21.

The controller 21 receives, as an NTP client, a time from the clock device 40 and distributes the received time to the entire system using the first function of the time synchronizing function of the monitor 10. Likewise the monitor 110 described above with reference to FIG. 9, the first function causes the clock device 40 serving as an NTP server to synchronize the respective times of the first time source 22, the second time source 24, the console 30, and the monitoring object device 50 with the time of the clock device 40.

Using the second function (i.e., manual time synchronizing function) of the time synchronizing function of the monitor 10, the controller 21 disables the time synchronization by the clock device 40 serving as the NTP server and instead distributes the time of the first time source 22 to the monitoring object device 50 and the console 30, using the first time source 22.

Here, the controller 21 can set, using the manual time synchronizing function of the time synchronizing function of the monitor 10, the time of the first time source 22 to the desired time that the user inputs via the console 30.

The above first and the second functions may cause the controller 21 to periodically distribute a time.

As the above, the controller 21 functions as a time distribution master that distributes a time to the monitoring object device 50 and the console 30.

Using the manual time synchronizing function of the time synchronizing function of the monitor 10, the console 30 of the first embodiment causes the controller 21 and the base monitor 23 to set a desired time (times) input by the user to the times of the first time source 22 and the second time source 24, respectively.

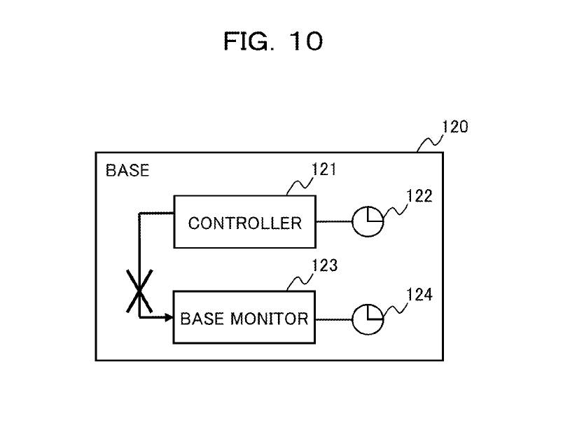

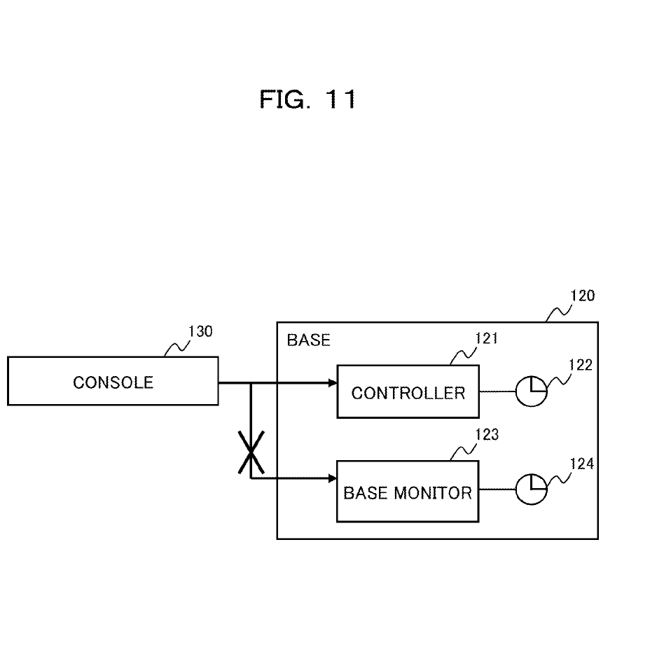

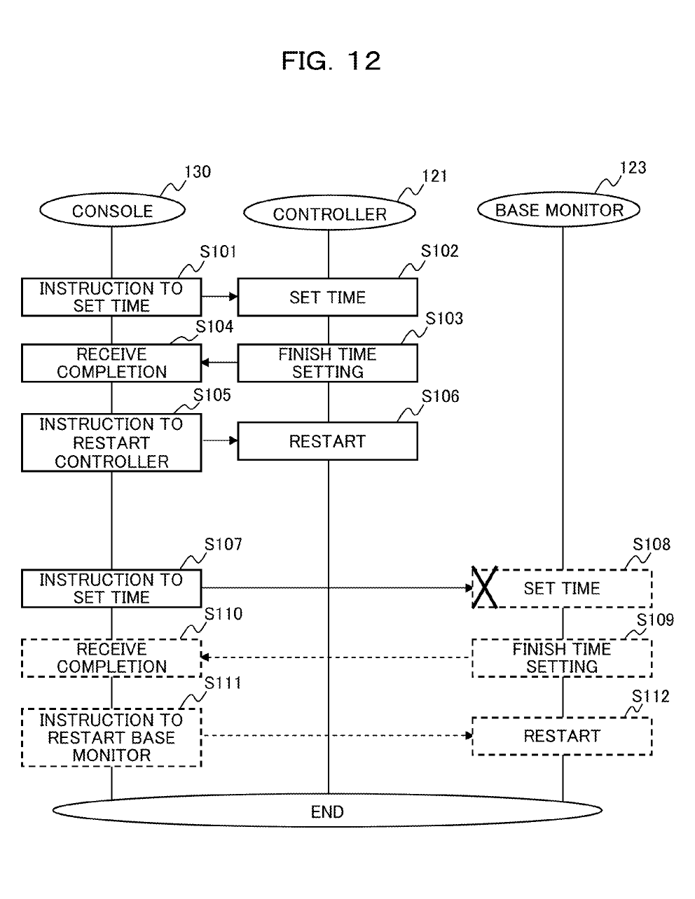

Likewise the case described above with reference to FIGS. 9-12, the setting a time in the second time source 24 of the base monitor 23 has an exclusive relationship with the state of the controller 21.

Hereinafter, description will now be made in relation to functional elements of the controller 21 and the console 30 that achieve the manual time synchronizing function of the first embodiment.

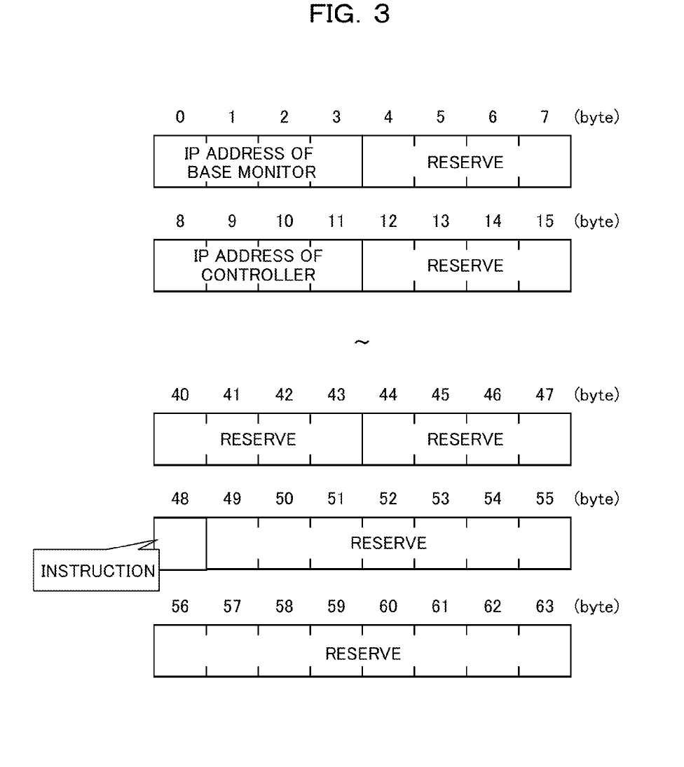

An exclusion information notifier 211 included in the controller 21 retains exclusion information representing an exclusive relationship between the controller 21 and the base monitor 23. The exclusion information will be detailed below with reference to FIG. 3. Upon receipt of an instruction to transmit exclusion information and an instruction to set the time from the console 30, the exclusion information notifier 211 notifies the exclusion information that the exclusion information notifier 211 retains to the console 30.

A first time setter 212 sets the time in the first time source 22 in response to the instruction to set a time from the console 30, and sets the time set in the first time source 22 also in the monitoring object device 50. Furthermore, upon completion of setting the time in the monitoring object device 50, the first time setter 212 transmits notification of time setting completion to the console 30.

The console 30 notifies the controller 21 of an instruction to transmit exclusion information and an instruction to set the time. After the notification of these instructions, the console 30 causes the stopper 31 and second time setter 32 to carry out the following process.

If the exclusion information received from the controller 21 represents that an exclusive relationship is established between the controller 21 and the base monitor 23, the stopper 31 included in the console 30 stops the controller 21 after receiving notification of time setting completion from the controller 21.

After the controller 21 is stopped, the second time setter 32 causes the base monitor 23 to set a time in the second time source 24.

After receiving notification of time setting completion from the base monitor 23, the restarter 33 restarts the base monitor 23. Furthermore, the restarter 33 restarts the controller 21 after the base monitor 23 is restarted.

As the above, the manual time synchronizing function of the first embodiment causes the controller 21 and the console 30 to synchronize the time of the second time source 24 in addition to the times of the monitoring object device 50 and the console 30 with the time of the first time source 22.

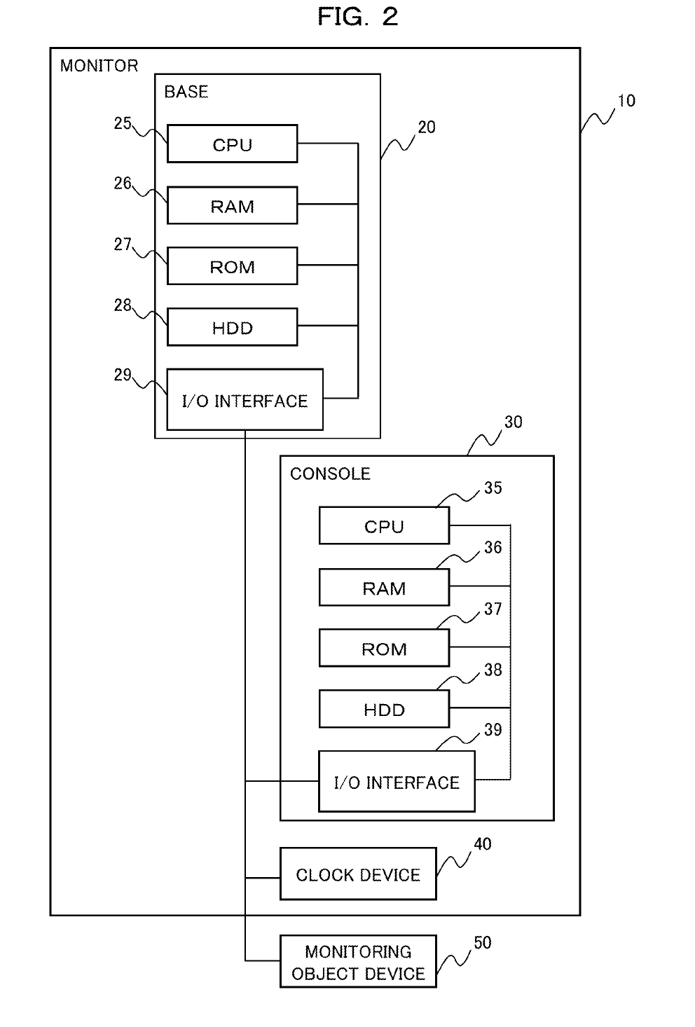

Next, description will now be made in relation to the hardware configurations of the base 20 and the console 30 with reference to FIG. 2.

FIG. 2 is a block diagram schematically illustrating an example of the hardware configuration of the base 20 and the console 30 of the first embodiment.

As illustrated in FIG. 2, the base 20 includes a Central Processing Unit (CPU) 25, a Random Access Memory (RAM) 26, a Read Only Memory (ROM) 27, a Hard Disk Drive (HDD) 28, and an I/O interface 29.

The CPU 25 is a processor that executes various controls and calculations of the base 20, and specifically achieves various functions by executing programs stored in the ROM 27. In the first embodiment, the CPU 25 functions as the controller 21, the exclusion information notifier 211, the first time setter 212, the first time source 22, and the base monitor 23 depicted in FIG. 1.

The register of the CPU 25 retains the exclusion information representing an exclusive relationship between the controller 21 and the base monitor 23 that will be detailed below with reference to FIG. 3.

The RAM 26 is a storage region that temporarily stores various pieces of data and programs, and is used for temporally storing or expanding data or programs when the CPU 25 executes the programs.

The ROM 27 is a memory device that retains programs and various pieces of data executed and used by the CPU 25; and the HDD 28 is another memory device that retains the various programs including the OS and various pieces of data.

The I/O interface 29 controls I/O devices, and is connected to the console 30, the clock device 40, the monitoring object device 50, and other devices. Specifically, the I/O interface 29 controls various I/O processing into and from the console 30, the clock device 40, the monitoring object device 50, and others.

As illustrated in FIG. 2, the console 30 includes a CPU 35, a RAM 36, a ROM 37, a HDD 38, and an I/O interface 39.

The CPU 35 is a processor that executes various controls and calculations of the console 30, and specifically achieves various functions by executing programs stored in the ROM 37. In the first embodiment, the CPU 35 functions as the stopper 31, the second time setter 32, and the restarter 33 depicted in FIG. 1.

The RAM 36 is a storage region that temporarily stores various pieces of data and programs, and is used for temporally storing or expanding data or programs when the CPU 35 executes the programs.

The ROM 37 is a memory device that retains programs and various pieces of data executed and used by the CPU 35; and the HDD 38 is another memory device to that retains the various programs including the OS and various pieces of data. The HDDs 28 and 38 may be substituted by other recording media, such as Solid State Drives (SSDs), usable in an information processing device.

The I/O interface 39 controls I/O devices, and is connected to the base 20, the clock device 40, the monitoring object device 50, and user interfaces (not illustrated) such as a display, a keyboard, and a mouse. Specifically, the I/O interface 39 controls various I/O processing into and from the base 20, the clock device 40, the monitoring object device 50, and user interfaces such as a display, a keyboard, and a mouse.

As illustrated in FIG. 2, the base 20 and the console 30 are achieved by respective different hardware devices, independent of each other, in the monitor 10.

FIG. 3 is a diagram illustrating an example of exclusion information retained in the controller 21 of the first embodiment.

The controller 21 causes the exclusion information notifier 211 to store the exclusion information representing the exclusive relationship between the controller 21 and the base monitor 23 depicted in FIG. 3 into the register of the CPU 25.

Upon receipt of an instruction to transmit exclusion information and an instruction to set the time from the console 30, the exclusion information notifier 211 of the controller 21 notifies the exclusion information stored in the register of the CPU 25 to the console 30.

In the example of FIG. 3, the IP (Internet Protocol) address of the exclusive subject side (exclusive source) between the controller 21 and the base monitor 23 is stored in the region of the 0th to the third bytes. In the first embodiment, the IP address of the base monitor 23 is stored in the region of the 0th to the third bytes.

When an exclusive relationship is not established between the controller 21 and the base monitor 23, 0xFF is set in the region of the 0th to the third bytes. In other words, 0xFF set in the region of the 0th to the third bytes means that an exclusive relationship is not established between the controller 21 and the base monitor 23.

The IP address of the exclusive object side (exclusive destination) between the controller 21 and the base monitor 23 is set in the region of the eighth to eleventh bytes. In the first embodiment, the IP address of the controller 21 itself is set in the region of the eighth to eleventh bytes.

In the region of the 48th byte, instruction information to the exclusive object side is set if an exclusive relationship is established between the controller 21 and the base monitor 23. In the first embodiment, instruction information to the controller 21 is set in the region of the 48th byte.

Here, instruction information represents information that instructs a process that the exclusive object side, that is the controller 21, carries out to cancel the exclusive relationship between the controller 21 and the base monitor 23.

For example, a rule is previously determined such that, when the digit “1” is set to be the instruction information in the region of the 48th byte, the exclusive object side, that is the controller 21, is to be stopped. Alternatively, any process that the exclusive object side is to carry out to cancel the exclusive relationship between the controller 21 and the base monitor 23 may be set to be instruction information.

Further alternatively, when the instruction information “0” is set in the region of the 48th byte for the purpose of the validation, the exclusive object side may be set to not carry out any process.

However, the above exclusion information is only an example. The regions in which the IP addresses of the exclusive object side and the exclusive subject side, and the instruction information are set are by no means limited to the above and may be arbitrary positions.

(A-2) Operation of First Embodiment:

Next, the operation of the information processing device 1 will now be described.

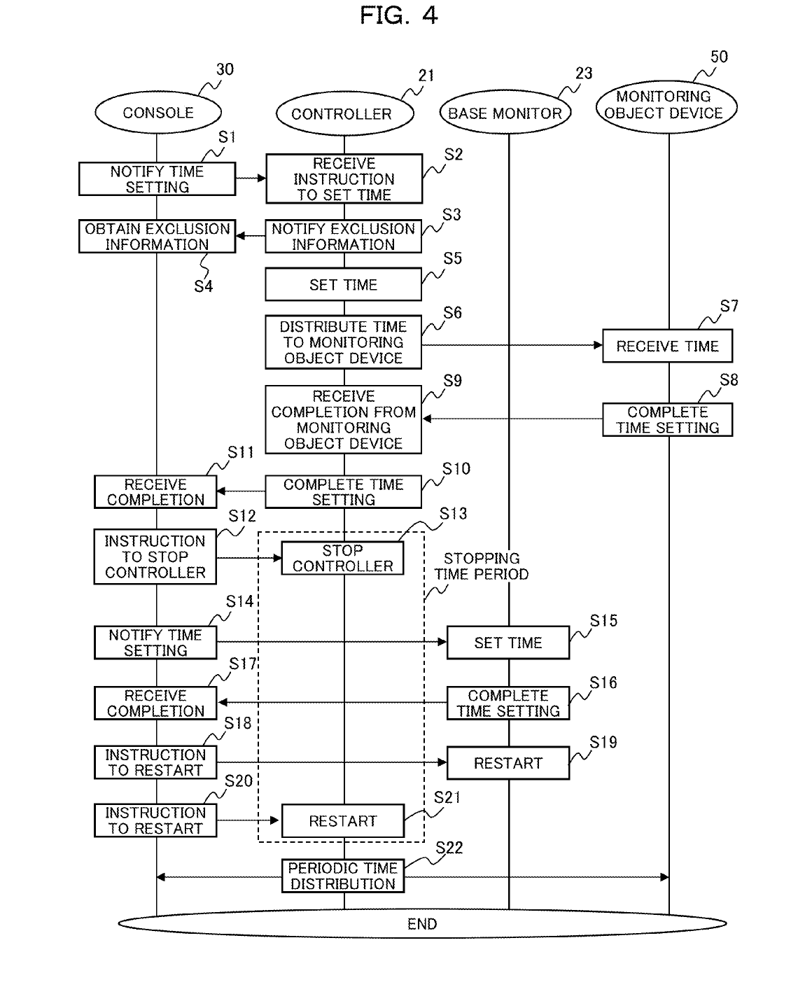

FIG. 4 is a sequence diagram denoting a succession of procedural steps of the manual time synchronizing function to be carried out in the information processing device 1 of the first embodiment.

The illustrated example assumes that an exclusive relationship is established between the controller 21 and the base monitor 23, and information to stop the controller 21 is set in the instruction information in the region of the 48th byte of the exclusion information stored in the register of the CPU 25.

As illustrated in FIG. 4, to begin with, the console 30 transmits, to the controller 21, an instruction to transmit exclusion information and an instruction to set a time in the first time source 22 (step S1). The instruction to set a time includes a desired time input by the user. After transmitting the instruction to set a time to the controller 21, the console 30 waits for exclusion information and notification of time setting completion from the controller 21.

After the controller 21 receives the instruction to transmit exclusion information and the instruction to set a time from the console 30 (step S2), the exclusion information notifier 211 of the controller 21 transmits the exclusion information representing the exclusive relationship between the controller 21 and the base monitor 23, the information being stored in the register of the CPU 25, to the console 30 (step S3; the step of notifying exclusion information).

Upon receiving and obtaining of the exclusion information from the exclusion information notifier 211 (step S4), the console 30 waits for notification of time setting completion from the controller 21.

After the controller 21 transmits the exclusion information to the console 30, the first time setter 212 of the controller 21 sets the time included in the instruction to seta time received from the console 30 at the step S2 in the first time source (step S5).

In succession, the first time setter 212 of the controller 21 distributes the time set in the first time source 22 to the monitoring object device 50 (step S6). After distribution of the time to the monitoring object device 50, the first time setter 212 waits for notification of time setting completion from the monitoring object device 50.

Upon receipt of the distributed time from the first time setter 212, the monitoring object device 50 sets the received time into the time source of the monitoring object device 50 itself (step S7).

Then, the monitoring object device 50 transmits notification of time setting completion to the first time setter 212 (step S8).

Upon receipt of the notification of time setting completion from the monitoring object device (step S9), the first time setter 212 notifies the console 30 of the completion of time setting (step S10).

The above steps S5, S6, S9, and S10 are carried out by the first time setter 212. Accordingly, the steps S5-S10 can be collectively regarded as a first time setting step.

Upon receipt of the notification of time setting completion from the first time setter 212 (step S11), the console 30 refers to the exclusion information obtained from the exclusion information notifier 211 in step S4 to confirm the presence or the absence of the exclusive relationship between the controller 21 and the base monitor 23.

If the console 30 determines that the exclusive relationship is established between the controller 21 and the base monitor 23, the stopper 31 of the console 30 transmits an instruction to stop to the controller 21, serving as an exclusive object side, on the basis of the instruction information included in the obtained exclusion information (step S12).

Upon receipt of the instruction to stop from the stopper 31, the controller 21 stops the controller 21 itself (step S13).

The above step S12 is carried out by the stopper 31. Accordingly, the steps S12 and S13 can be collectively regarded as a stopping step.

After the controller 21 stops in step S13, the console 30 causes the second time setter 32 of the console 30 to notify the base monitor 23 of an instruction to set a time in the second time source (step S14). Likewise the above step S1, the instruction to set a time includes a desired time input by the user. Upon notification of the instruction to set a time to the base monitor 23, the second time setter 32 waits for notification of time setting completion from the base monitor 23.

Upon receipt of the instruction to set a time from the second time setter 32, the base monitor 23 sets the time included in the received instruction to set a time in the second time source 24 (step S15).

Then, the base monitor 23 notifies the second time setter 32 of time setting completion (step S16) and the second time setter 32 receives the notification of time setting completion from the base monitor 23 (step S17).

The above steps S14 and S17 are carried out by the second time setter 32. Accordingly, the steps S14-S17 can be collectively regarded as a second time setting step.

Next, the restarter 33 of the console 30 notifies an instruction to restart to the base monitor 23 (step S18) so that the time set in the second time source 24 is reflected in the base monitor 23.

Upon receipt of the instruction to restart from the restarter 33, the base monitor 23 restarts the base monitor 23 itself (step S19).

After the restarting the base monitor 23 is completed, the restarter 33 notifies an instruction to restart to the controller 21 (step S20), so that the time set in the first time source 22 is reflected in the controller 21.

Upon receipt of the instruction to restart from the restarter 33, the controller 21 restarts the controller 21 itself (step S21).

The above steps S18 and S20 are carried out by the restarter 33. Accordingly, the steps S18-S21 can be collectively regarded as a restarting step.

As described above, the time of the first time source 22 is calculated on the basis of the time differential value depending on the time of the second time source 24 and the time of the second time source 24. In order to exactly reflect the times of the first time source 22 and the second time source 24 respectively in the controller 21 and the base monitor 23, the restarter 33 restarts the controller 21 after the restarting the base monitor 23 in step S19 is completed.

As described above, the second time setter 32 sets the time in the base monitor 23 while the controller 21 is stopping during the stopping time period between the step S13 and S21 in the procedure of FIG. 4.

Along the above procedural steps, the console 30 successfully sets the time in the controller 21, the base monitor 23, and the monitoring object device 50.

After the console 30 completes the time setting in the controller 21, the base monitor 23, and the monitoring object device 50, the controller 21 periodically distributes, as the time distribution master, a time to the monitoring object device 50 and the console 30 using the manual time synchronizing function (step S22).

When the console 30 determines that the exclusive relationship is not established between the controller 21 and the base monitor 23 in above step S12, there is no need to stop the controller 21 during a time is being set in the base monitor 23.

In this case, the console 30 does not cause the stopper 31 to notify the instruction to stop to the controller 21 in step S12, and instead does cause the restarter 33 to notify the instruction to restart to the controller 21 in step S20. In other words, the process of steps S12 and S13 is substituted by the process of steps of S20 and S21. Concurrently, after the completion of the process of step S19, the process of the steps S20 and S21 is skipped and the process of step S22 is then carried out.

As described above, the exclusion information notifier 211 of the first embodiment retains the exclusion information representing the exclusive relationship between the controller 21 and the base monitor 23.

This makes the stopper 31 of the first embodiment to determine whether the exclusion information received from the controller 21 represents that the exclusive relationship is established between the controller 21 and the base monitor 23.

When the exclusive relationship that the base monitor 23 is prohibited from setting a time in the second time source 24 under the state where the controller 21 is running, the stopper 31, the second time setter 32, and the restarter 33 included in the console 30 set a time in the base monitor 23 during the stooping time period of the controller 21.

Thereby, even when the exclusive relationship is established between the controller 21 and the base monitor 23, the time of the first time source 22 of the controller 21 can be synchronized with the time of the second time source 24 of the base monitor 23.

Furthermore, the first time setter 212 of the first embodiment sets the time in the first time source 22 in response to an instruction to set a time from the console 30, and the time set in the first time source 22 is further set in the monitoring object device 50. After the time setting in the monitoring object device 50 is completed, the notification of time setting completion is transmitted to the console 30.

Even when the exclusion information received from the controller 21 represents that an exclusive relationship exists between the controller 21 and the base monitor 23, the stopper 31 stops the controller 21 after receiving the notification of time setting completion from the controller 21.

Since the controller 21 is stopped by the stopper 31 after the first time setter 212 included in the controller 21 sets a time in the monitoring object device 50, the first time setter 212 successfully sets the time in the monitoring object device 50 before the controller 21 is stopped by the stopper 31.

Furthermore, after the first time setter 212 sets the time in the first time source 22 of the controller 21, the second time setter 32 sets the time of the second time source 24 of the base monitor 23.

The restarter 33 restarts the controller 21 after the base monitor 23 is restarted.

This can successfully synchronize the time of the first time source 22 with the time of the second time source 24 even when the time of the first time source 22 is calculated on the basis of the time differential value depending on the time of the second time source 24 and the time of the second time source 24.

### (B) Second Embodiment

(B-1) Configuration of Second Embodiment:

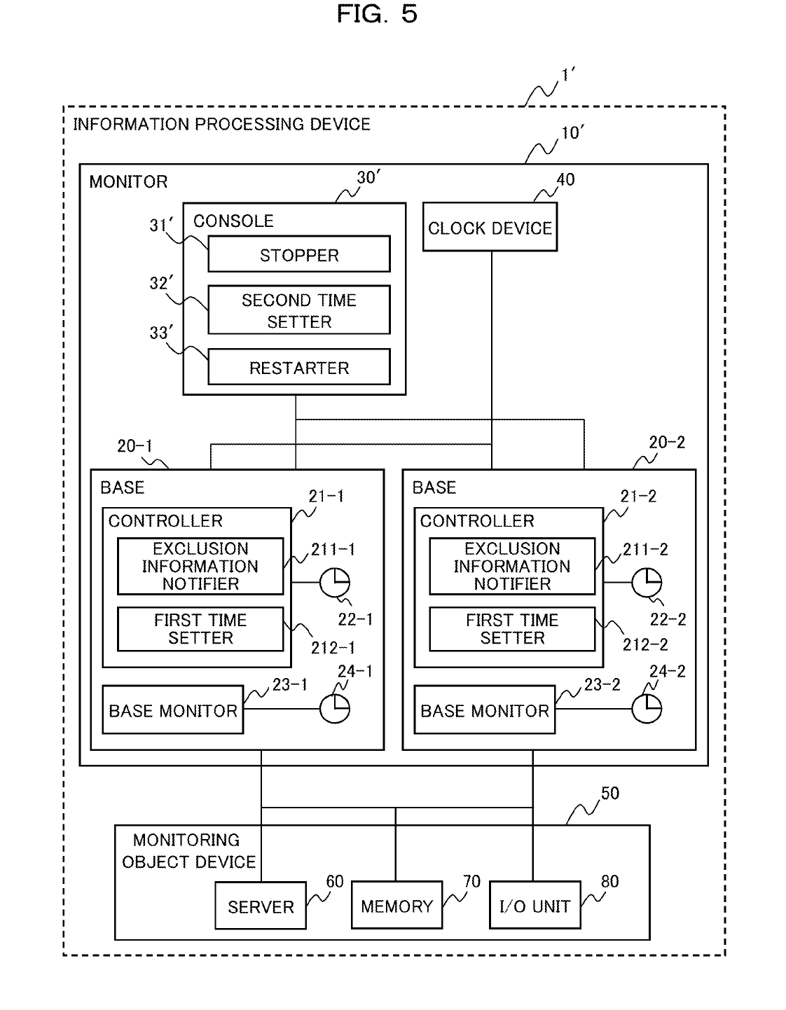

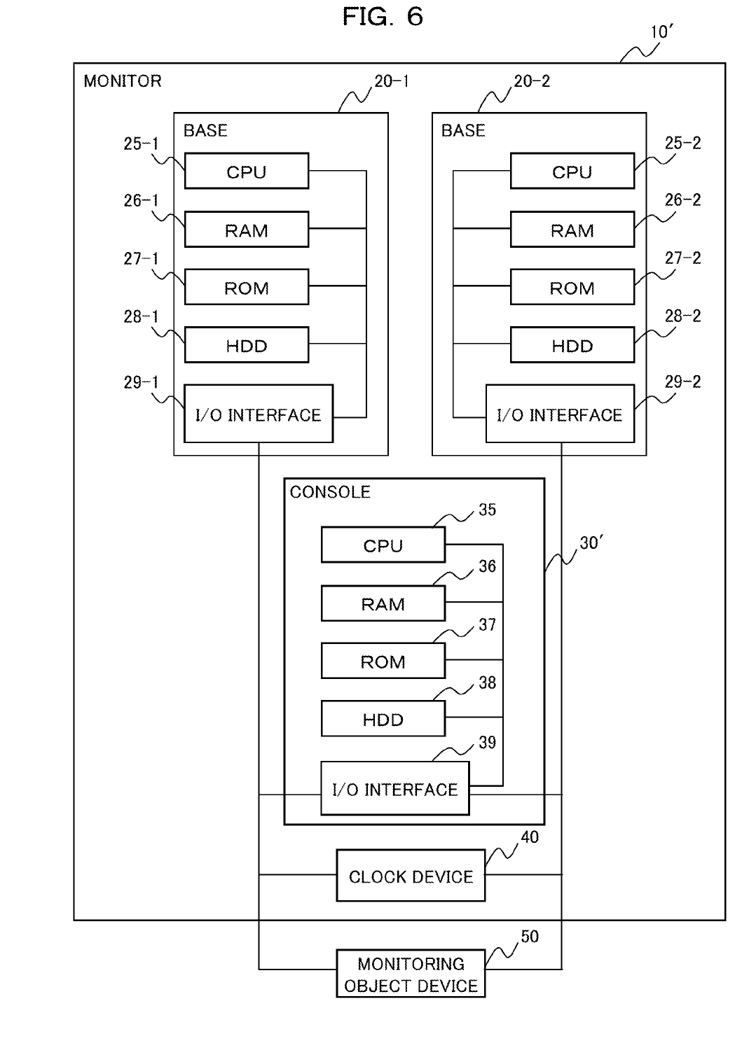

The configuration of the information processing device 1 should by no means be limited to that of the first embodiment detailed above, and may alternatively be an information processing device 1′ having two redundant bases 20 as depicted in FIGS. 5 and 6 according to the second embodiment.

Like reference numbers of the information processing device 1′ in FIGS. 5 and 6 designate the same or substantially same parts and elements as those of the information processing device 1 of the above first embodiment, so detailed description thereof is omitted here.

FIG. 5 is a block diagram schematically illustrates an example of the configuration of the information processing device 1′ according to the second embodiment.

As illustrated in FIG. 5, the information processing device 1′ includes a monitor 10′ and the monitoring object device 50.

The monitor 10′ regards at least one server 60, a memory 70, and at least one I/O unit 80 as an integrated monitoring object device 50, and monitors the integrated monitoring object device 50. The monitor 10′ includes bases 20-1 and 20-1, a console 30′, and a clock device 40.

The bases 20-1 and 20-2 monitor the monitoring object device 50 and the console 30′. The base 20-1 includes a controller 21-1, a first time source 22-1, a base monitor 23-1, and a second time source 24-1, and the base 20-2 includes a controller 21-2, a first time source 22-2, a base monitor 23-2, and a second time source 24-2.

The base 20-2, a stand-by base redundant to the base 20-1, is in a stand-by state when the base 20-1 is operating and comes to operate when the base 20-1 stops.

For the sake of convenience, the base 20-2 is also referred to as the stand-by base 20-2.

To each of the bases 20-1 and 20-2, the console 30′, the clock device 40, and the monitoring object device 50 are connected. While the base 20-1 is operating, the base 20-1 carries out processing that is carried out by the base 20 of FIG. 1 on the console 30′, the clock device 40, and the monitoring object device 50. On the other hand, while the base 20-1 is stopped, the stand-by base 20-2 carries out the same operation as that of the base 20 of FIG. 1 on the console 30′, the clock device 40, and the monitoring object device 50.

The controllers 21-1 and 21-2, the first time sources 22-1 and 22-2, the base monitors 23-1 and 23-2, and the second time sources 24-1 and 24-2 are the same in function as the controller 21, the first time source 22, the base monitor 23, and the second time source 24 included in the information processing device 1 of FIG. 1, respectively, so description common to these elements between the first and the second embodiments is omitted here.

The controller 21-1 includes an exclusion information notifier 211-1 and a first time setter 212-1, and the controller 21-2 includes an exclusion information notifier 211-2 and a first time setter 212-2.

The exclusion information notifiers 211-1 and 211-2 and the first time setters 212-1 and 212-2 will be detailed below.

For the sake of convenience, the controller 21-2, the first time source 22-2, the base monitor 23-2, and the second time source 24-2 that the base 20-2 includes are referred to as the stand-by controller 21-2, the stand-by first time source 22-2, the stand-by base monitor 23-2, and the stand-by second time source 24-2, respectively.

The console 30′ is the same in function as the console 30 included in the information processing device 1 depicted in FIG. 1, so detailed description thereof is omitted here.

The console 30′ includes a stopper 31′, a second time setter 32′, and a restarter 33′, which will be detailed below.

The monitor 10′ has a time synchronizing function to distribute a time to the entire system from the controller 21-1 while the controller 21-1 is operating and from the stand-by controller 21-2 when the controller 21-1 is stopped likewise the controller 21 of FIG. 1.

Hereinafter, the reference numbers 20-1 and 20-2 are used to discriminate one base from the other, but an arbitrary base is represented by the reference number 20. Similarly, the reference numbers 21-1 and 21-2 are used to discriminate one controller from the other, but an arbitrary controller is represented by the reference number 21; the reference numbers 22-1 and 22-2 are used to discriminate one first time source from the other, but an arbitrary first time source is represented by the reference number 22.

The reference numbers 23-1 and 23-2 are used to discriminate one base monitor from the other, but an arbitrary base monitor is represented by the reference number 23; and the reference numbers 24-1 and 24-2 are used to discriminate one second time source from the other, but an arbitrary second time source is represented by the reference number 24.

The reference numbers 211-1 and 211-2 are used to discriminate one exclusion information notifier from the other, but an arbitrary exclusion information notifier is represented by the reference number 211; and the reference numbers 212-1 and 212-2 are used to discriminate one first time setter from the other, but an arbitrary first time setter is represented by the reference number 212.

The controller 21 receives, serving as an NTP client, a time from the clock device 40 and distributes the received time to the entire system using the first function of the time synchronizing function of the monitor 10′. In other words, the first function causes the clock device 40 serving as an NTP server to synchronize the respective times of the first time sources 22-1 and 22-2, the second time sources 24-1 and 24-2, the console 30′, and the monitoring object device 50 with the time of the clock device 40.

Using the second function (i.e., manual time synchronizing function) of the time synchronizing function of the monitor 10′, the controller 21 disables the time synchronization by the clock device 40 serving as the NTP server, and instead distributes the time of the first time source 22 to the controller 21 in a stand-by state, the monitoring object device 50 and the console 30′.

Here, the controller 21 can set, using the manual time synchronizing function of the monitor 10′, the time of the first time source 22 to the desired time that the user inputs via the console 30′.

The above first and the second functions may cause the controller 21 to periodically distribute a time.

As the above, the controller 21 functions as a time distribution master that distributes a time to the controller 21 in a stand-by state, the monitoring object device 50 and the console 30′.

Using the manual time synchronizing function of the time synchronizing function of the monitor 10′, the console 30′ of the second embodiment causes the controllers 21 and the base monitors 23 to set a desired time input by the user to the times of the first time source 22-1 and the second time source 24-1 and the first time source 22-2 and the second time source 24-2 that are in a stand-by state.

The time setting in the second time source 24-1 in the base monitor 23-1 has an exclusive relationship with the state of the controller 21-1, and the time setting in the stand-by time source 24-2 in the stand-by base monitor 23-2 has an exclusive relationship with the state of the stand-by controller 21-2.

Hereinafter, description will now be made in relation to functional elements of each controller 21 and the console 30′ that achieve the manual time synchronizing function of the second embodiment.

Since the stand-by controller 21-2 serves as a kind of redundant replacement that functions when the controller 21-1 is stopped, the functional elements of the stand-by controller 21-2 are the same as those of the controller 21-1. Accordingly, description of the functional elements of the controller 21-2 will be omitted here.

The description below assumes that the controller 21-1 is operating.

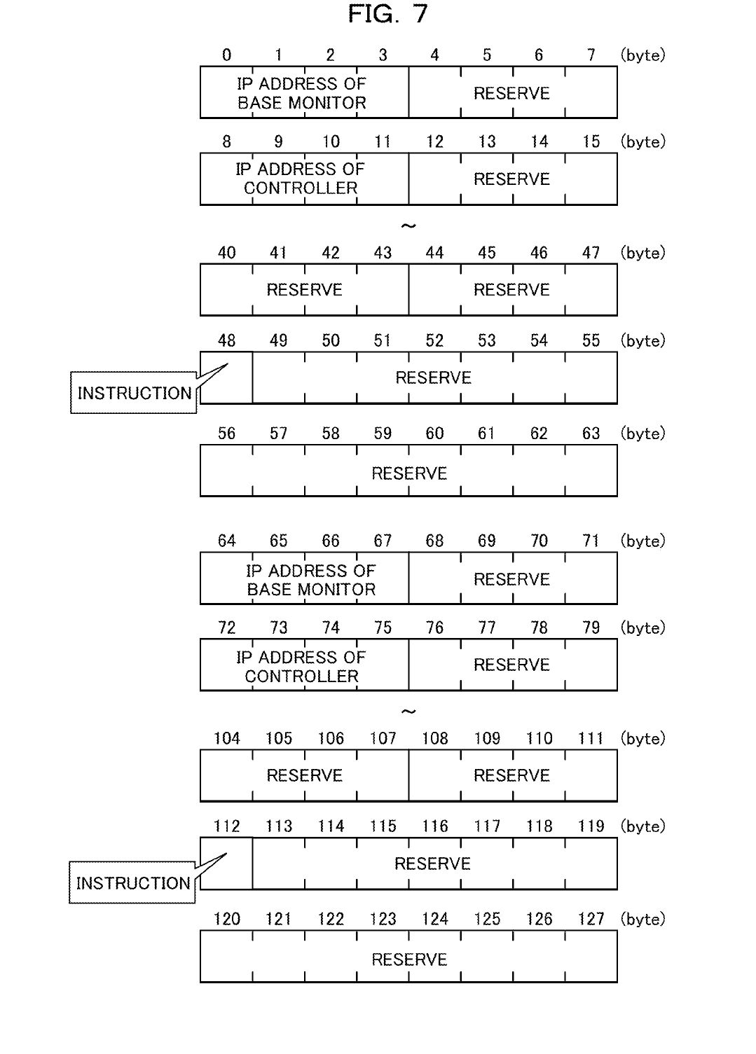

An exclusion information notifier 211-1 included in the controller 21-1 retains exclusion information representing an exclusive relationship between the controller 21-1 and the base monitor 23-1 and also retains exclusion information representing an exclusive relationship between the stand-by controller 21-2 and the stand-by base monitor 23-2. The exclusion information will be detailed below with reference to FIG. 7. Upon receipt of an instruction to transmit exclusion information and an instruction to set a time from the console 30′, the exclusion information notifier 211-1 notifies the exclusion information that the exclusion information notifier 211-1 retains to the console 30′.

A first time setter 212-1 sets a time in the first time source 22-1 in response to the instruction to set a time from the console 30′, and sets the time set in the first time source 22-1 also in the first time source 22-2 of the stand-by controller 21-2. Further, after the setting of the time in the first time source 22-2 is completed, the first time setter 212-1 sets the time set in the first time source 22-1 in the monitoring object device 50. Then, upon completion of time setting in the monitoring object device 50, the first time setter 212-1 transmits notification of time setting completion to the console 30′.

The console 30′ notifies the controller 21-1 of an instruction to transmit exclusion information and an instruction to set a time. After the notification of these instructions, the console 30′ causes the stopper 31′, the second time setter 32′, and the restarter 33′ to carry out the following process.

If the exclusion information received from the controller 21 represents that at least one of an exclusive relationship between the controller 21-1 and the base monitor 23-1 and an exclusive relationship between the stand-by controller 21-2 and the stand-by base monitor 23-2 is established, the stopper 31′ included in the console 30′ stops the controller 21 being in the exclusive relationship after receiving notification of time setting completion from the same controller 21.

After the stopper 31′ stops the controller 21 in the exclusive relationship, the second time setter 32′ causes the base monitors 23-1 and 23-2 to set a time in the second time sources 24-1 and 24-2, respectively.

After receiving notification of time setting completion from the base monitors 23-1 and 23-2, the restarter 33′ restarts the base monitors 23-1 and 23-2. Furthermore, the restarter 33′ restarts the controller 21 after the restarting of the base monitors 23 is completed.

As the above, the manual time synchronizing function of the second embodiment causes the controller 21 and the console 30′ to synchronize the time of the second time sources 24-1 and 24-2 in addition to the times of the monitoring object device 50 and the console 30 with the time of the first time sources 22-1 and 22-2.

Next, description will now be made in relation to the hardware configurations of the bases 20 and the console 30′ with reference to FIG. 6.

FIG. 6 is a block diagram schematically illustrating an example of the hardware configurations of the bases 20 and the console 30′ of the second embodiment.

As illustrated in FIG. 6, the base 20-1 includes a CPU 25-1, a RAM 26-1, and a ROM 27-1, a HDD 28-1, and an I/O interface 29-1 while the base 20-2 includes a CPU 25-2, a RAM 26-2, a ROM 27-2, a HDD 28-2, and an I/O interface 29-2.

Since the CPUs 25-1 and 25-2, the RAMs 26-1 and 26-2, the ROMs 27-1 and 27-2, the HDDs 28-1 and 28-2, and the I/O interfaces 29-1 and 29-2 are same in configuration with the CPU 25, the RAM 26, the ROM 27, the HDD 28, and the I/O interface 29 of FIG. 2, respectively, detailed description thereof will be omitted here.

The CPU 25-1 functions as the controller 21-1, the exclusion information notifier 211-1, the first time setter 212-1, the first time source 22-1, and the base monitor 23-1 as illustrated in FIG. 5. Meanwhile, the CPU 25-2 functions as the controller 21-2, the exclusion information notifier 211-2, the first time setter 212-2, the first time source 22-2, and the base monitor 23-2 as illustrated in FIG. 5.

The registers of the CPUs 25-1 and 25-2 each retain the exclusion information representing an exclusive relationship between the controller 21-1 and the base monitor 23-1 and an exclusive relationship between the stand-by controller 21-2 and the stand-by base monitor 23-2 that will be detailed below with reference to FIG. 7.

Hereinafter, reference numbers 25-1 and 25-2 will be used when one CUP needs to be discriminated from the other, but an arbitrary CPU is represented by a reference number 25.

The I/O interfaces 29-1 and 29-2 each control I/O devices, and are each connected to the console 30′, the clock device 40, the monitoring object device 50, and other devices. Specifically, the I/O interfaces 29-1 and 29-2 control various I/O processing into and from the console 30′, the clock device 40, the monitoring object device 50, and others.

As illustrated in FIG. 6, the console 30′ includes a CPU 35, a RAM 36, a ROM 37, a HDD 38, and an I/O interface 39, which respectively have the same configurations as the CPU 35, the RAM 36, the ROM 37, the HDD 38, and the I/O interface 39 of FIG. 2. For this, detailed description of the common points of these functional elements of FIG. 6 with those of FIG. 2 will be omitted here.

The CPU 35 functions as the stopper 31′, the second time setter 32′, and the restarter 33′ as illustrated in FIG. 5.

The I/O interface 39 controls I/O devices, and is connected to the bases 20-1 and 20-2, the clock device 40, the monitoring object device 50, and user interfaces (not illustrated) such as a display, a keyboard, and a mouse. Specifically, the I/O interface 39 controls various I/O processing into and from the bases 20-1 and 20-2, the clock device 40, the monitoring object device 50, and user interfaces such as a display, a keyboard, and a mouse.

As illustrated in FIG. 6, the bases 20-1 and 20-2 form a redundant system in the monitor 10′ and respectively have hardware devices independent from each other. The bases 20 and the console 30′ are achieved by respective different hardware devices, independent of one other, in the monitor 10′.

FIG. 7 is a diagram illustrating an example of exclusion information retained in the controllers 21 of the second embodiment.

The controllers 21 cause the corresponding exclusion information notifiers 211 to store the exclusion information representing the exclusive relationship between the controller 21-1 and the base monitor 23-1 and the exclusion information representing the exclusive relationship between the stand-by controller 21-2 and the stand-by base monitor 23-2 depicted in FIG. 7 into the register of the CPU 25.

Upon receipt of an instruction to transmit exclusion information and an instruction to set a time from the console 30′, the exclusion information notifiers 211 of the controllers 21 notify the exclusion information stored in the register of the respective CPUs 25 to the console 30′.

In the example of FIG. 7, the exclusive relationship between the controller 21-1 and the base monitor 23-1 is stored in a region of the 0th to the 63th bytes in the same format as that of FIG. 3. Similarly, the exclusive relationship between the stand-by controller 21-2 and the stand-by base monitor 23-2 is stored in a region of the 64th-127th bytes in the same format as that of FIG. 3. As the above, the exclusion information stored into the register of each CPU 25 provides a region of a predetermined bytes to each combination of a controller 21 and a base monitor 23. Specifically, a region of 64 bytes is provided to each combination of a controller 21 and a base monitor 23.

The region of the 0th-63th bytes of FIG. 7 is described above with reference to FIG. 3, so description will now be made in relation to the region of the 64th-127th bytes.

In the example of FIG. 7, the IP address of the exclusive subject side (exclusive source) between the stand-by controller 21-2 and the stand-by base monitor 23-2 are stored in the region of the 64th-67th bytes. In the second embodiment, the IP address of the stand-by base monitor 23-2 is stored in the region of the 64th-67th bytes.

If the exclusive relationship is not established between the stand-by controller 21-2 and the stand-by base 23-2, 0xFF is set into the region of the 64th-67th bytes. In other words, if 0xFF is set in the region of the 64th-67th bytes, no exclusive relationship is established between the stand-by controller 21-2 and the stand-by base 23-2.

The IP address of the exclusive object side (exclusive destination) between the stand-by controller 21-2 and the stand-by base 23-2 is set in the region of the 72th-75th bytes. In the second embodiment, the IP address of the stand-by controller 21-2 itself is set in the region of the 72th-75th bytes.

In the region of the 112th byte, instruction information to the exclusive object side is set if an exclusive relationship is established between the stand-by controller 21-2 and the stand-by base monitor 23-2. In the second embodiment, instruction information to the stand-by controller 21-2 is set in the region of the 112th byte.

Here, as described above with reference to FIG. 3, instruction information represents a process that the exclusive object side, that is the stand-by controller 21-2, carries out to cancel the exclusive relationship between the stand-by controller 21-2 and the stand-by base monitor 23-2.

For example, a rule is previously determined such that, when the digit “1” is set to be the instruction information in the region of the 112th byte, the exclusive object side, that is the stand-by controller 21-2, is to be stopped. Alternatively, any process that the exclusive object side is to carry out to cancel the exclusive relationship between the stand-by controller 21-2 and the stand-by base 23-2 may be set to be instruction information.

Further alternatively, when the instruction information “0” is set in the region of the 112th byte for the purpose of the validation, it may be possible that the exclusive object side does not carry out any process.

However, the above exclusion information is only an example. The regions in which the IP addresses of the exclusive object side and the exclusive subject side, and the instruction information are set are by no means limited to the above and may be arbitrary positions.

(B-2) Operation of Second Embodiment:

Next, the operation of the information processing device 1′ will now be described.

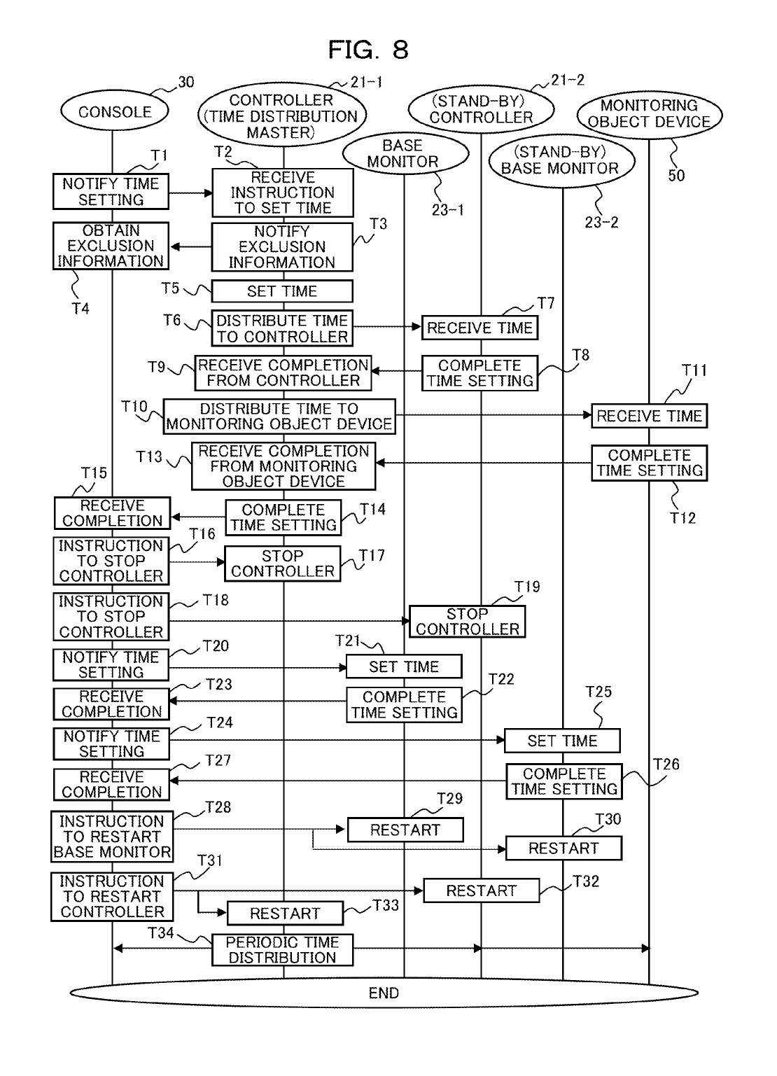

FIG. 8 is a sequence diagram denoting a succession of procedural steps of the manual time synchronizing function of the information processing device 1′ of the second embodiment.

The illustrated example assumes that an exclusive relationship is established between the controller 21-1 and the base monitor 23-1 and also between the controller 21-2 and the base monitor 23-2, and information to stop the controllers 21-1 and 21-2 is set in the instruction information respectively at the regions of the 48th byte and the 112th bytes of the exclusion information stored in the register of the CPU 25.

As illustrated in FIG. 8, to begin with, the console 30′ transmits, to the controller 21-1 serving as the time distribution master, an instruction to transmit exclusion information and an instruction to set a time in the first time source 22-1 (step T1). The instruction to set a time includes the arbitrary time input by the user. After transmitting the instruction to set a time to the controller 21-1, the console 30′ waits for exclusion information and notification of time setting completion from the controller 21-1.

After the controller 21-1 receives the instruction to transmit exclusion information and the instruction to set a time from the console 30′ (step T2), the exclusion information notifier 211-1 of the controller 21-1 transmits the exclusion information representing the exclusive relationship between the controller 21-1 and the base monitor 23-1, the exclusion information representing the exclusive relationship between the stand-by controller 21-2 and the stand-by base monitor 23-2, the information being stored in the register of the CPU 25-1, to the console 30′ (step T3; the step of notifying exclusion information).

Upon receiving and obtaining of the exclusion information from the exclusion information notifier 211-1 (step T4), the console 30′ waits for notification of time setting completion from the controller 21-1.

After the controller 21-1 transmits the exclusion information to the console 30′, the first time setter 212-1 of a controller 21-1 sets the time included in the instruction to set the time received from the console 30′ at the step T2 in the first time source 22-1 (step T5).

In succession, the first time setter 212-1 of the controller 21-1 distributes the time set in the first time source 22-1 to the stand-by controller 21-2 (step T6). After distribution of the time to the stand-by controller 21-1, the first time setter 212-1 waits for notification of time setting completion from the stand-by controller 21-2.

Upon receipt of time distributed from the first time setter 212-1, the stand-by controller 21-2 sets the received time in the stand-by first time source 22-2 in the stand-by controller 21-2 itself (step T7).

Then the stand-by controller 21-2 transmits notification of time setting completion to the first time setter 212-1 (step T8).

Upon receipt of the notification of time setting completion from the stand-by controller 21-2 (step T9), the first time setter 212-1 distributes the time set in the first time source 22-1 to the monitoring object device 50 (step T10). Upon the distribution of the time to the monitoring object device 50, the first time setter 21-1 waits for notification of time setting completion from the monitoring object device 50.

Upon receipt of the first time distributed from the first time setter 212-1, the monitoring object device 50 sets the received time in the time source of the monitoring object device 50 itself (step T11).

Then, the monitoring object device 50 transmits notification of time setting completion to the first time setter 212-1 (step T12).

Upon receipt of the notification of time setting completion from the monitoring object device (step T13), the first time setter 212-1 notifies the console 30′ of the completion of time setting (step T14).

The above steps T5, T6, T9, T10, T13, and T14 are carried out by the first time setter 212. Accordingly, the steps T5-T14 can be collectively regarded as a first time setting step.

Upon receipt of the notification of time setting completion from the first time setter 212-1 (step T15), the console 30′ refers to the exclusion information obtained from the exclusion information notifier 211-1 in step T4 to confirm the presence or the absence of the exclusive relationship between the controller 21-1 and the base monitor 23-1 and the presence or absence of the exclusive relationship between the stand-by controller 21-2 and the stand-by base monitor 23-2.

If the console 30′ determines that the exclusive relationship is established both between the controller 21-1 and the base monitor 23-1 and between the stand-by controller 21-2 and the stand-by base monitor 23-2, the stopper 31′ of the console 30′ transmits an instruction to stop to the controller 21-1, that is an exclusive object side, on the basis of the instruction information included in the obtained exclusion information (step T16).

Upon receipt of the instruction to stop from the stopper 31′, the controller 21-1 stops the controller 21-1 itself (step ST17).

The stopper 31′ of the console 30′ transmits an instruction to stop to the stand-by controller 21-2, that is an exclusive object side, on the basis of the instruction information included in the obtained exclusion information (step T18).

Upon receipt of the instruction to stop from the stopper 31′, the stand-by controller 21-2 stops the stand-by controller 21-2 itself (step ST19).

The above steps T16 and T18 are executed by the stopper 31′, and therefore correspond to a stopping step.

After the controller 21-1 stops in the step T17, the console 30′ causes the second time setter 32′ therein to transmit an instruction to set a time in the second time source 24-1 to the base monitor 23-1 (step T20). Likewise the step T1, the instruction to set a time includes the arbitrary time input by the user. Upon notification of the instruction to set a time to the base monitor 23-1, the second time setter 32′ waits for notification of time setting completion from the base monitor 23-1.

Upon receipt of the instruction to set a time from the second time setter 32′, the base monitor 23-1 sets the time included in the received instruction to set a time in the second time source 24-1 (step T21).

Then, the base monitor 23-1 notifies the second time setter 32′ of completion of time setting (step T22), and the second time setter 32′ receives the notification of time setting completion from the base monitor 23-1 (step T23).

After the stand-by controller 21-2 stops in the step T19, the console 30′ causes the second time setter 32′ therein to transmit an instruction to set a time in the stand-by second time source 24-2 to the stand-by base monitor 23-2 (step T24). Upon notification of the instruction to set a time to the stand-by base monitor 23-2, the second time setter 32′ waits for notification of time setting completion from the stand-by base monitor 23-2.

Upon receipt of the instruction to set a time from the second time setter 32′, the stand-by base monitor 23-2 sets the time included in the received instruction to set a time in the stand-by second time source 24-2 (step T25).

Then, the stand-by base monitor 23-2 notifies the second time setter 32′ of completion of time setting (step T26) and the second time setter 32′ receives the notification of time setting completion from the stand-by base monitor 23-2 (step T27).

The above steps T20, T23, T24, and T27 are executed by the second time setter 32′ and therefore the steps T20-T27 correspond to a second time setting step.

Next, the restarter 33′ of the console 30′ transmits an instruction to restart to the base monitors 23-1 and 23-2 (step T28) so that the times set in the second time sources 24-1 and 24-2 are reflected in the base monitors 23-1 and 23-2, respectively.

Upon receipt of an instruction to restart from the restarter 33′, the base monitor 23-1 restarts the base monitor 23-1 itself (step T29) while upon receipt of an instruction to restart from the restarter 33′, the stand-by base monitor 23-2 restarts the stand-by base monitor 23-2 (step T30).

After restarting of the base monitors 23-1 and 23-2 is completed, the restarter 33′ transmits an instruction to restart to the controllers 21-1 and 21-2 (step T31) so that the times set in the first time sources 22-1 and 22-2 are reflected in the controllers 21-1 and 21-2, respectively.

Upon receipt of an instruction to restart from the restarter 33′, the controller 21-1 restarts the controller 21-1 itself (step T32) while upon receipt of an instruction to restart from the restarter 33′, the stand-by controller 21-2 restarts the stand-by controller 21-2 itself (step T33).

The above steps T28 and T31 are executed by the restarter 33′, and therefore steps T28-T31 can be collectively regarded as a restarting step.

As described above, the time of the first time source 22-1 is calculated on the basis of a time differential value depending on the time of the second time source 24-1 and the time of the second time source 24-1 while the time of the stand-by first time source 22-2 is calculated on the basis of a time differential value depending on the time of the stand-by second time source 24-2 and the time of the stand-by second time source 24-2. In order to exactly reflect the times of the first time sources 22 and the second time sources 24 in the controllers 21 and the base monitors 23, the restarter 33′ restarts the controllers 21-1 and 21-2 after the completion of restarting the base monitors 23-1 and 23-2 in steps T29 and T30.

As described above, the second time setter 32′ sets the time in the base monitor 23-1 during the stopping time period of the controller 21-1 between steps T17 and T33 in the procedure of FIG. 8 while the second time setter 32′ sets the time in the stand-by base monitor 23-2 during the stopping time period of the stand-by controller 21-2 between steps T19 and T32 in the procedure of FIG. 8

Along the above procedural steps, the console 30′ sets the times in the controllers 21, the base monitors 23, and the monitoring object device 50.

After the console 30′ completes the time setting in the controllers 21, the base monitor 23, and the monitoring object device 50, the controller 21-1 periodically distributes, as the time distribution master, a time to the monitoring object device 50 and the console 30′ using the manual time synchronizing function (step T34).

When the console 30′ determines that the exclusive relationship is not established between the controller 21-1 and the base monitor 23-1 in above step T16, it is possible to not stop the controller 21-1 while a time is being set in the base monitor 23-1.

In this case, the console 30′ does not cause the stopper 31′ to notify the instruction to stop to the controller 21-1 in step T16 and instead does cause the restarter 33′ to notify the instruction to restart to the controller 21-1 in step T31. In other words, the process of steps T16 and T17 are substituted by the process of steps of T31 and T33. Concurrently, after the completion of the process of step T30, the instruction to restart is not notified to the controller 21-1 in step T31, but the instruction to restart is notified to the stand-by controller 21-2 in step T31.

When the console 30′ determines that the exclusive relationship is not established between the stand-by controller 21-2 and the stand-by base monitor 23-2 in above step T18, it is possible to not stop the stand-by controller 21-2 while a time is being set in the stand-by base monitor 23-2.

In this case, the console 30′ does not cause the stopper 31′ to notify the instruction to stop to the stand-by controller 21-2 in step T18, and instead does cause the restarter 33′ to notify the instruction to restart to the stand-by controller 21-2 in step T31. In other words, the process of steps T18 and T19 are substituted by the process of steps of T31 and T32. Concurrently, after the completion of the process of step T30, the instruction to restart is not notified to the stand-by controller 21-2 in step T31, but the instruction to restart is notified to the controller 21-1 in step T31.

Thereby, in the information processing device 1′ of the second embodiment, likewise the above information processing device 1, even when the exclusive relationship is established between the controllers 21 and the base monitors 23, the time of the first time sources 22 of the controllers 21 can be synchronized with the time of the second time sources 24 of the base monitors 23.

Each exclusion information notifier 211 of the second embodiment retains exclusion information representing the exclusive relationship between the controller 21-1 and the base monitor 23-1 and exclusion information representing the exclusive relationship between the stand-by controller 21-2 and the stand-by base monitor 23-2.

For the above, the stopper 31′ of the second embodiment can determine whether the exclusion information received from the controller 21 represents the exclusive relationship between the controller 21-1 and the base monitor 23-1 and also determine whether the exclusion information received from the controller 21 represents the exclusive relationship between the stand-by controller 21-2 and the stand-by base monitor 23-2.

Accordingly, as described above with reference to FIG. 8, when the exclusive relationship is established between the controller 21-1 and the base monitor 23-1 and the exclusive relationship is established between the stand-by controller 21-2 and the stand-by base monitor 23-2, the console 30′ is capable of synchronizing the times of the first time sources 22 of the controllers 21 with the times of the second time sources 24 of the base monitors 23. When the exclusive relationship is established between the controller 21-1 and the base monitor 23-1 while the exclusive relationship is not established between the stand-by controller 21-2 and the stand-by base monitor 23-2 and vice versa, the console 30′ is capable of synchronizing the times of the first time sources 22 of the controllers 21 with the times of the second time sources 24 of the base monitors 23.

The controller 21-1 (the first time setter 212-1) being operating serves as the time distribution master and therefore distributes a time to the other controller 21-2 and the monitoring object device 50. The console 30′ (the second time setter 32′) distributes a time to the base monitors 23-1 and 23-2 while the controllers 21-1 and 21-2 are stopping.

Thereby, even in the information processing device 1′ of FIG. 5, which includes redundant bases 20 and increases the time sources, can synchronize the times of the first time sources 22 of the controllers 21 with the time of the second time sources 24 of the base monitors 23.

In addition, after the first time setter 212 sets the time of the first time source 22-1 of the controller 21-1, the second time setter 32 sets the time of the second time source 24-1 of the base monitor 23-1. Furthermore, after the restarter 33 restarts the base monitor 23-1, the controller 21-1 is restarted.

In the same manner, after the first time setter 212 sets the time of the stand-by first time source 22-2 of the stand-by controller 21-2, the second time setter 32 sets the time of the stand-by second time source 24-2 of the stand-by base monitor 23-2. Furthermore, after the restarter 33 restarts the stand-by base monitor 23-2, the stand-by controller 21-2 is restarted.

With this configuration, even when the time of the first time source 22-1 is calculated on the basis of the time differential value depending of the time of the second time source 24-1 and the time of the second time source 24-1, the times of the first time source 22-1 and the second time source 24-1 can be synchronized with each other. Likewise, even when the time of the stand-by first time source 22-2 is calculated on the basis of the time differential value depending of the time of the stand-by second time source 24-2 and the time of the second time source 24-2, the times of the stand-by first time source 22-2 and the stand-by second time source 24-2 can be synchronized with each other.

(C) Others:

Preferable embodiments of the present invention are detailed as the above. The present invention should by no means be limited to the foregoing embodiments, and various changes and modifications can be suggested without departing from the concept of the present invention.

For example, as illustrated in FIGS. 1 and 5, description is made on the information processing devices 1 and 1′, in which each base 20 includes single controller 21 and single first time source 22. Alternatively, the number of controllers 21 and that of first time sources 22 included in a single base 20 are not limited to one.

Alternatively, multiple controllers 21 and multiple first time sources 22 may be included in a single base 20.

In this case, one of the multiple controllers 21 functions as a master, which causes the first time setter 212 to distribute a time to the monitoring object device 50 and the remaining controllers 21. Upon receipt of an instruction to stop from the stopper 31 or 31′ of the console 30 or 30′, the controller 21 serving as the master firstly restarts the remaining controllers 21 and after the restarting of the remaining controllers 21 is completed, restarts the controller 21 serving as the master itself.

Thereby, the base 20 including multiple controllers 21 and multiple first time sources 22 brings the same advantages as those of the above first and second embodiments.

The above description is made on cases where the console 30 or 30′ concurrently sets the time of the first time source 22 of the controller 21 and the time of the second time source 24 of the base monitor 23 with reference to FIGS. 1-8. However, the present invention is not limited to the above.

Alternatively, the console 30 or 30′ may set one of a time of the first time source 22 of the controller 21 and a time of the second time source 24 of the base monitor 23. In this case, when a time of the second time source 24 of the base monitor 23 is to be set, a controller 21 that establishes the to exclusive relationship with the base monitor 23 having the second time source 24 in which a time is to be set on the basis of the exclusion information representing the exclusive relationship between the controller 21 and the base monitor 23 is to beset to stop, as detailed the above.

Furthermore, the above description is made in relation to the controller 21 setting a time in the monitoring object device 50 with reference to FIGS. 1-8. However, the present invention is not limited to this.

Alternatively, if setting a time in the monitoring object device 50 can be omitted or if the monitoring object device 50 is not connected to the monitor 10 or 10′, the controller 21 may omit to set a time in a monitoring object device 50. In this case, steps S6-S9 of FIG. 4 or steps T10-T13 of FIG. 8 are to be omitted.

The above description made with reference to FIGS. 1-8 assumes that the exclusion information notifier 211 of the controller 21 manages exclusion information representing the exclusive relationship between the controller 21 and the base monitor 23. However, the present invention is not limited to this.

Alternatively, if the user that operates the console 30 or 30′ grasps the exclusive relationship between the controller 21 and the base monitor 23 in advance, the exclusion information notifier 211 can be omitted. In this case, steps S3 and S4 of FIG. 4 and steps T3 and T4 of FIG. 8 can be omitted. In step S12 of FIG. 4 or step T16 of FIG. 8, it is sufficient that the user causes the console 30 or 30′ to notify an instruction to stop the controllers 21.

The CPU 25 of the base 20 executing the first time setting program functions as the controller 21, the exclusion information notifier 211, the first time setter 212, the first time source 22, and the base monitor 23.

The CPU 35 of the console 30 and 30′ executing the second time setting program functions as the stopper 31 and 31′, the second time setter 32 and 32′, and the restarter 33 and 33′.

In the above embodiments, the first time setting program and the second time setting program are integrated into a time setting program. However, the present invention is not limited to this. Alternatively, the first time setting program and the second time setting program may be provided independently from each other.

The program (the time setting program) to achieve the functions of the controller 21, the exclusion information notifier 211, the first time setter 212, the first time source 22, the base monitor 23, the stopper 31 and 31′, the second time setter 32 and 32′, and the restarter 33 and 33′ is provided in the form of being stored in a computer-readable recording medium such as a flexible disk, a CD (e.g., CD-ROM, CD-R, CD-RW), and a DVD (e.g., DVD-ROM, DVD-RAM, DVD-R, DVD+R, DVD-RW, DVD+RW, HD DVD), a Blu-ray disk, a magnetic disk, an optical disk, and a magneto-optical disk. The computer reads the program from the recording medium and forwards and stores the program into an internal or external memory for future use. The program may be stored in a storage device (recording medium), such as a magnetic disk, an optical disk, and a magneto-optical disk, and may be provided to a computer from the storage device through a communication route.

The functions of the controller 21, the exclusion information notifier 211, the first time setter 212, the first time source 22, the base monitor 23, the stopper 31 and 31′, the second time setter 32 and 32′, and the restarter 33 and 33′ are achieved by a microprocessor (corresponding to the CPU 25 of the base 20 and the CPU 35 of the console 30 or 30′ in the foregoing embodiments) executing a program stored in an internal memory (corresponding to the RAM 26, the ROM 27, or the HDD 28 of the base 20 and the RAM 36, the ROM 37, or the HDD 38 of the console 30 or 30′ in the foregoing embodiments). Alternatively, a computer may read a program stored in a recording medium and execute the read program.

In the first embodiment, a computer is a concept of a combination of hardware and an Operating System (OS), and means hardware which operates under control of the OS. Otherwise, if a program operates hardware independently of an OS, the hardware corresponds to the computer. Hardware includes at least a microprocessor such as a CPU and means to read a computer program recorded in a recording medium. In the foregoing embodiments, the base 20 and the console 30 or 30′ serve to function as a computer.

The technique disclosed above has an advantage of easily setting a time into the second time source even when time setting in the second time source establishes an exclusive relationship with the state of the controller in an information processing device.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although an embodiment of the present inventions has been described in detail, it should be understood that the various changes, substitutions, and alterations could be made hereto without departing from the spirit and scope of the invention.

What is claimed is:

1. An information processing device comprising a monitoring object device and a monitor that monitors the monitoring object device,
the monitor comprising:
a console that controls the information processing device in accordance with instruction information input through a user interface; and
a base that monitors the monitoring object device,
the base comprising
a first time source that supplies a first time of the entire part of the information processing device based on time information from an external entity of the information processing device,
a second time source that has a second time different from the first time of the first time source,
a controller that controls the first time source and the monitoring object device, and
a base monitor that controls the second time source and monitors the base,
the controller comprising a first time setter that sets the first time in the first time source in accordance with an instruction to set a time from the console, that sets the first time, which is set in the first time source, in the monitoring object device, and that, upon completion of the setting of the first time in the monitoring object device, transmits a notification of time setting completion to the console, and
the console comprising
a stopper that stops, when an exclusive relationship that the base monitor is prohibited from setting the second time in the second time source under a state where a controller is running is established, the controller after the console receives the notification of time setting completion from the controller,
a second time setter that causes, after the controller is stopped, the base monitor to set the second time in the second time source, and
a restarter that restarts, upon receipt of a notification of time setting completion from the base monitor, the controller and the base monitor.

2. The information processing device according to claim 1, wherein the first time of the first time source is calculated using the second time of the second time source.

3. The information processing device according to claim 1, wherein:
the second time source is a Time Of Day (TOD) clock; and
the first time source is a logical TOD clock that retains a time differential value between a time used in the controller and the second time of the second time source and that calculates the first time of the first time source by adding the second time of the second time source and the time differential value.

4. The information processing device according to claim 1, wherein exclusion information representing the exclusive relationship comprises an Internet Protocol (IP) address of the base monitor that is to exclude, an IP address of the controller that is to be excluded, and control information to control the controller to be excluded.

5. The information processing device according to claim 1, further comprising a stand-by base that is in a stand-by state while the base is operating and that operates when the base is stopped, the stand-by base being the same as the base, wherein:
the controller further comprises an exclusion information notifier that notifies, upon receipt of the instruction to set a time from the console, the console of exclusion information representing an exclusive relationship between a stand-by controller that the stand-by base comprises and a stand-by base monitor that the sand-by base comprises and representing the exclusive relationship between the controller and the base monitor;
the first time setter sets the first time in the first time source in accordance with the instruction to set a time from the console, sets the first time, which is set in the first time source, in the stand-by controller and the monitoring object device, and transmits, upon completion of the setting of the time in the stand-by controller and the monitoring object device, a notification of time setting completion to the console;
the stopper stops, when the exclusion information received from the controller indicates that an exclusive relationship is established at least one of between the controller and the base monitor and between the stand-by controller and the stand-by base monitor, at least one of the controller and the stand-by controller that establishes the exclusive relationship after receiving the notification of time setting completion from the controller;
the second time setter causes, after at least one of the controller and the stand-by controller that establishes the exclusive relationship is stopped, the second time sources to set the second time in the base monitor and the stand-by base monitor; and
the restarter restarts, upon receipt of notifications of time setting completion from the base monitor and the stand-by base monitor, at least one of the combinations of the controller and the base monitor, and the stand-by controller and the stand-by base monitor

6. The information processing device according to claim 1, wherein:
the controller is a hypervisor that controls an Operating System (OS); and
the base monitor is a service processor.

7. A computer-readable recording medium having stored therein a program for causing a computer to execute a process for setting a time in the computer that comprises a monitoring object device and a monitor that monitors the monitoring object device, the monitor comprising a console that controls the computer in accordance with instruction information input through a user interface and a base that monitors the monitoring object device, the base comprising a first time source that supplies a first time of the entire part of the computer based on time information from an external entity of the computer, a second time source that has a second time different from the first time of the first time source, a controller that controls the first time source and the monitoring object device, and a base monitor that controls the second time source and monitors the base, the process comprising:
causing the controller to set the first time in the first time source in accordance with an instruction to set a time from the console, set the first time, which is set in the first time source, in the monitoring object device, and transmit, upon completion of the setting of the first time in the monitoring object device, a notification of time setting completion to the console; and
causing the console to
stop, when an exclusive relationship that the base monitor is prohibited from setting the second time in the second time source under a state where a controller is running is established, the controller after receiving the notification of time setting completion from the controller,
cause, after stopping the controller, the base monitor to set the second time in the second time source, and
restart, upon receipt of a notification of time setting completion from the base monitor, the controller and the base monitor.

8. The computer-readable recording medium according to claim 7, wherein the first time of the first time source is calculated using the second time of the second time source.

9. The computer-readable recording medium according to claim 7, wherein the first time of the first time source is calculated by adding the second time of the second time source and a time differential value between a time used in the controller and the second time of the second time source.

10. The computer-readable recording medium according to claim 7, wherein exclusion information representing the exclusive relationship comprises an Internet Protocol (IP) address of the base monitor that is to exclude, an IP address of the controller that is to be excluded and control information to control the controller to be excluded.

11. A monitor that monitors a monitoring object device, the monitor comprising:
a console that controls the monitor in accordance with instruction information input through a user interface; and
a base that monitors the monitoring object device,
the base comprising
a first time source that supplies a first time of the entire part of the monitor based on time information from an external entity of the monitor,
a second time source that has a second time different from the first time of the first time source,
a controller that controls the first time source and the monitoring object device, and
a base monitor that controls the second time source and monitors the base,
the controller comprising a first time setter that sets the first time in the first time source in accordance with an instruction to set a time from the console, and that, upon completion of the setting of the first time in the first time source, transmits a notification of time setting completion to the console, and
the console comprising
a stopper that stops, when an exclusive relationship that the base monitor is prohibited from setting the second time in the second time source under a state where a controller is running is established, the controller after the console receives the notification of time setting completion from the controller,
a second time setter that causes, after the controller is stopped, the base monitor to set the second time in the second time source, and
a restarter that restarts, upon receipt of a notification of time setting completion from the base monitor, the controller and the base monitor.

12. A method for setting a time in the information processing device by a monitor that monitors a monitoring object device, the information processing device comprises the monitoring object device and the monitor, the monitor comprising a console that controls the information processing device in accordance with instruction information input through a user interface and a base that monitors the monitoring object device, the base comprising a first time source that supplies a first time of the entire part of the information processing device based on time information from an external entity of the information processing device, a second time source that has a second time different from the first time of the first time source, a controller that controls the first time source and the monitoring object device, and a base monitor that controls the second time source and monitors the base, the method comprising:
causing the controller to set the first time in the first time source in accordance with an instruction to set a time from the console, set the first time, which is set in the first time source, in the monitoring object device, and transmit, upon completion of the setting of the first time in the monitoring object device, a notification of time setting completion to the console; and
causing the console to
stop, when an exclusive relationship that the base monitor is prohibited from setting the second time in the second time source under a state where a controller is running is established, the controller after receiving the notification of time setting completion from the controller,
cause, after stopping the controller, the base monitor to set the second time in the second time source, and
restart, upon receipt of a notification of time setting completion from the base monitor, the controller and the base monitor.
